(19) United States
(12) Patent Application Publication
(10) Pub. No.: US 2007/0235279 A1
(43) Pub. Date: Oct. 11, 2007

(54) Automotive oil-bath clutch

(75) Inventor: Franco Cimatti, Pavullo (IT)

Correspondence Address: GRAYBEAL, JACKSON, HALEY LLP, 155 - 108TH AVENUE NE, SUITE 350, BELLEVUE, WA, 98004-5973, US

(73) Assignee: FERRARI S.p.A.

(21) Appl. No.: 11/605,841

(22) Filed: Nov. 28, 2006

Related U.S. Application Data
(63) Continuation-in-part of application No. PCT/EP05/52404, filed on May 26, 2005.

(30) Foreign Application Priority Data
May 28, 2004 (IT) BO2004 A 000342

(51) Int. Cl. F16D 13/74

(52) U.S. Cl. 192/70.12

(57) ABSTRACT

An automotive oil-bath clutch has at least one disk mounted inside a housing to rotate about a longitudinal axis; the housing being bounded by a lateral wall extending about the disk.

### PRIORITY CLAIM

This is a continuation-in-part application which claims priority from PCT/EP2005/052404, published in English, filed May 26, 2005, which claims priority from Italian patent Application No. BO2004 A 000342, filed May 28, 2004, which are incorporated herein by reference.

### TECHNICAL FIELD

An embodiment of the present invention relates to an automotive oil-bath clutch.

More specifically, an embodiment of the present invention relates to an automotive oil-bath clutch of the type comprising at least one disk mounted inside a housing to rotate about a substantially horizontal longitudinal axis.

The housing has a lubricating oil inlet, and normally extends about and beneath the clutch disk to define a tank at the bottom to catch the lubricating oil which falls by force of gravity into the tank.

Documents U.S. Pat. No. 3,474,888, U.S. Pat. No. 3,768,613, and U.S. Pat. No. 4,474,278, which are incorporated by reference, relate to an automotive oil-bath clutch comprising one disk mounted inside a housing to rotate about a substantially horizontal longitudinal axis. The housing has a lubricating oil inlet, and extends about the clutch disk.

### BACKGROUND

Known oil-bath clutches of the type described above have various drawbacks, mainly on account of the lubricating oil tank at the bottom making them relatively bulky. Moreover, since the clutch disk is immersed continually in the lubricating oil, known oil-bath clutches of the above type also have the further drawback of being relatively inefficient.

### SUMMARY

An embodiment of the present invention provides an automotive oil-bath clutch designed to eliminate the above drawbacks, and which is also cheap and easy to produce.

### BRIEF DESCRIPTION OF THE DRAWING

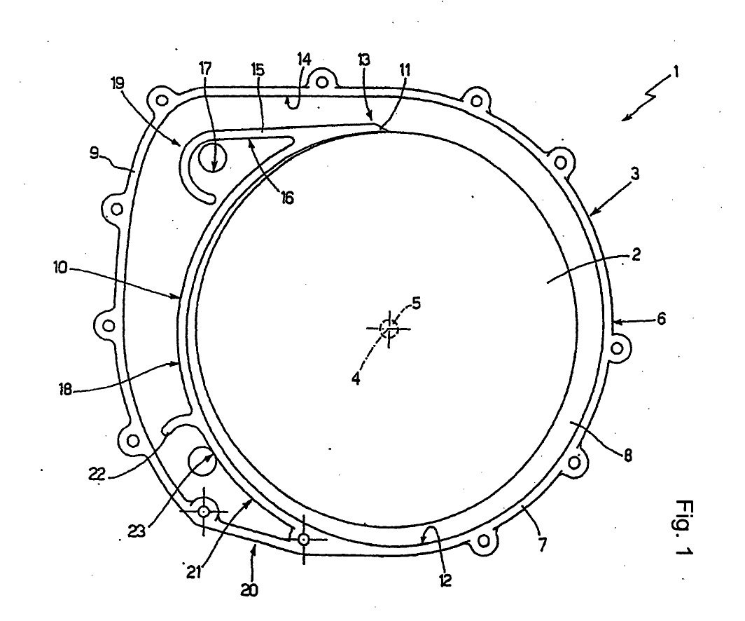

A non-limiting embodiment of the present invention will be described by way of example with reference to FIG. 1, which shows a schematic side view with parts removed for clarity.

### DETAILED DESCRIPTION

Number 1 in FIG. 1 indicates as a whole an automotive oil-bath clutch comprising at least one substantially circular disk 2 mounted inside a housing 3 to rotate in a given rotation direction (anticlockwise in the example shown) about a substantially horizontal longitudinal axis 4.

Housing 3 has an axial inlet 5 for feeding lubricating oil into housing 3, and is bounded by a lateral wall 6 comprising a first portion 7 extending substantially 3600 about axis 4 to define a chamber 8 housing disk 2; and a second portion 9 extending approximately but no more than 180° about portion 7 to define, together with portion 7, an outlet channel 10 for the lubricating oil from chamber 8. Wall 6 is also designed to separate chamber 8 from channel 10 by means of a blade-like edge 11 substantially parallel to axis 4.

Portion 7 defines, together with disk 2, a feed channel 12 for feeding lubricating oil about axis 4. Channel 12 is connected to an inlet end 13 of channel 10, and increases in radial width in the rotation direction of disk 2.

Channel 10 comprises a substantially straight first portion 14 extending from end 13, substantially tangent to disk 2, and bounded laterally on one side by portion 9, and on the other side by a substantially hook-shaped plate 15, which projects from portion 7, is positioned with its concavity facing downwards, and defines, with portion 7, a top chamber 16 for collecting the gaseous phase of the lubricating oil.

Chamber 16 has an outlet hole 17, for the gaseous phase of the lubricating oil from housing 3, substantially parallel to axis 4 and shielded by plate 15 to prevent the liquid phase of the lubricating oil from reaching hole 17.

Channel 10 also comprises a second portion 18, which extends downwards about axis 4 from a first end 19 connected to portion 14, decreases in radial width in the rotation direction of disk 2, and terminates at a second end 20 shaped to define a bottom tank 21 for collecting the liquid phase of the lubricating oil.

Tank 21 is bounded at the top by a plate 22 projecting inside portion 18 to prevent backflow of the liquid phase of the lubricating oil along portion 18, and has an outlet hole 23, for the liquid phase of the lubricating oil from housing 3, substantially parallel to axis 4.

In actual use, lubricating oil is fed into chamber 8 through inlet 5, and is fed along feed channel 12 by rotation of disk 2, whose movement comprises a centrifugal component to press the lubricating oil against wall 6, and a tangential component for feeding the lubricating oil along feed channel 12 in the rotation direction of disk 2.

Once the lubricating oil comes to the end of feed channel 12 and first portion 14 of outlet channel 10, the gaseous phase of the lubricating oil is collected inside top chamber 16 and exhausted from housing 3 through outlet hole 17, and the liquid phase of the lubricating oil is collected inside bottom tank 21 and drained from housing 3 through outlet hole 23.

Clutch 1 therefore requires no lubricating oil tank beneath disk 2, and is therefore relatively compact.

From the foregoing it will be appreciated that, although specific embodiments of the invention have been described herein for purposes of illustration, various modifications may be made without deviating from the spirit and scope of the invention.

1) An automotive oil-bath clutch comprising at least one disk mounted to rotate in a given rotation direction about a longitudinal axis; and a housing for housing the disk; the housing comprising a chamber, which houses the disk, is bounded by a lateral wall facing the disk and extending about the disk, and has a lubricating oil inlet; characterized in that the distance between the disk and the lateral wall increases in the rotation direction of disk about said axis.

2) A clutch as claimed in claim 1, wherein the housing also comprises an outlet channel for the lubricating oil from said chamber; the channel comprising at least a substantially straight first portion tangent to the disk.

3) A clutch as claimed in claim 2, wherein said first portion is substantially horizontal; the channel comprising a second portion substantially extending about said axis and extending downwards from a first end connected to said first portion.

4) A clutch as claimed in claim 3, wherein the lubricating oil comprises a liquid phase and a gaseous phase; the channel comprising, at said first end, a first outlet for said gaseous phase from the housing.

5) A clutch as claimed in claim 4, wherein the channel also comprises first shielding means to prevent said liquid phase from reaching said first outlet.

6) A clutch as claimed in claim 3, wherein the second portion extends between said first end and a second end, which is shaped to define a bottom tank for collecting said liquid phase.

7) A clutch as claimed in claim 6, wherein the bottom tank has a second outlet for said liquid phase from the housing.

8) A clutch as claimed in claim 6, wherein the channel also comprises second shielding means to prevent backflow of said liquid phase from the bottom tank and along said second portion.

9) A clutch as claimed in claim 3, wherein the second portion extends between said first end and a second end, and substantially decreases in radial width from the first to the second end.

10) A clutch as claimed in claim 4, wherein the second portion extends between said first end and a second end, which is shaped to define a bottom tank for collecting said liquid phase.

11) A clutch as claimed in claim 5, wherein the second portion extends between said first end and a second end, which is shaped to define a bottom tank for collecting said liquid phase.

12) A clutch as claimed in claim 7, wherein the channel also comprises second shielding means to prevent backflow of said liquid phase from the bottom tank and along said second portion.

13) A clutch as claimed in claim 4, wherein the second portion extends between said first end and a second end, and substantially decreases in radial width from the first to the second end.

14) A clutch as claimed in claim 5, wherein the second portion extends between said first end and a second end, and substantially decreases in radial width from the first to the second end.

15) A clutch as claimed in claim 6, wherein the second portion extends between said first end and a second end, and substantially decreases in radial width from the first to the second end.

16) A clutch as claimed in claim 7, wherein the second portion extends between said first end and a second end, and substantially decreases in radial width from the first to the second end.

17) A clutch as claimed in claim 8, wherein the second portion extends between said first end and a second end, and substantially decreases in radial width from the first to the second end.
